(19) United States
(12) Patent Application Publication
(10) Pub. No.: US 2019/0266884 A1
(43) Pub. Date: Aug. 29, 2019

(54) Inspection System and Method

(71) Applicant: PnewSoft, LLC, Cypress, TX (US)

(72) Inventors: Mark Popkowski, Tomball, TX (US); David Seek, San Rafael, CA (US)

(73) Assignee: PnewSoft, LLC, Cypress, TX (US)

(21) Appl. No.: 16/287,680

(22) Filed: Feb. 27, 2019

Related U.S. Application Data
(60) Provisional application No. 62/635,800, filed on Feb. 27, 2018.

(51) Int. Cl. G08B 29/14; G08B 29/12; G08B 17/00; A62C 37/50

(52) U.S. Cl. CPC G08B 29/145; A62C 37/50; G08B 17/00; G08B 29/123

(57) ABSTRACT

A media device may comprise an interface wherein the interface is configured to display prompts to a life safety inspector and guide a life safety inspector through a life safety inspection. The prompts may comprise questions or directions to the life safety inspector to perform an action. The life safety inspector may enter answers into a test box or similar input in response to the prompt. A server comprising a database may interface with the media device over the internet and allow the media device to upload a life safety inspector's inputs into the database. A life safety equipment inspection report may then be generated from the database.

### CROSS-REFERENCE TO RELATED APPLICATIONS

This application claims priority to U.S. Provisional Patent Application No. 62/635,800, filed on Feb. 27, 2018, titled “Inspection System and Method,” the entire disclosure of which is herein incorporated by reference.

### BACKGROUND OF THE INVENTION

### Field of the Invention

This invention relates to the field of life safety equipment inspection and more specifically to the field of software systems and methods for fire equipment inspection.

### Background of the Invention

Physical documents for various life safety equipment inspection suffer many well-known drawbacks. For example, transferring a physical document from one location to another requires the physical transfer of the document. Physical documents may be incomplete with respect to equipment actually installed at a commercial building. The use of digital documents provides solutions to these and other common issues. However, each commercial building may require a custom digital document to enumerate all the equipment in the building as each commercial building may have various life safety equipment. Additionally, there may be many code regulations such as federal, state, and local that may determine the extent and procedures to follow during an inspection.

Consequently, there is a need for an improved life safety equipment inspection system and method for collecting and reporting data obtained during an inspection that complies with federal, state, and local regulations.

### BRIEF SUMMARY OF SOME OF THE INVENTION

These and other needs in the art are addressed in one embodiment by a life safety equipment inspection system and method that allows a user to complete a life safety equipment inspection using a media device.

A media device may comprise an interface wherein the interface is configured to display prompts to a life safety inspector and guides the life safety inspector through the process of an inspection of life safety equipment. The prompts may comprise questions or directions to the life safety inspector to perform an action. The life safety inspector may enter answers into a test box or similar input in response to the prompt. A server comprising a database may interface with the media device over the internet and allow the media device to upload a life safety inspector's inputs into the database. A life safety inspection report may then be generated from the database.

The foregoing has outlined rather broadly the features and technical advantages of the present embodiments in order that the detailed description that follows may be better understood. It should be appreciated by those skilled in the art that the conception and the specific embodiments disclosed may be readily utilized as a basis for modifying or designing other embodiments for carrying out the same purposes of the present invention.

### BRIEF DESCRIPTION OF THE DRAWINGS

These drawings illustrate certain aspects of some examples of the present disclosure, and should not be used to limit or define the disclosure.

FIG. 1 illustrates a flow chart of a fire inspection method;

FIG. 2 illustrates a communication system between a media device and database;

FIG. 3 illustrates an example of database.

### DETAILED DESCRIPTION OF THE INVENTION

As previously stated, there may be many challenges to the use of paper documents in an inspection for life safety equipment. Commercial building operators may be required by code, ordinances, laws, and other regulations to perform a regular life safety equipment inspection of a building that the operators manage. A life safety inspector or a plurality of inspectors may perform a life safety equipment inspection on a commercial building. An inspection may comprise testing each piece of life safety equipment for functionality, inspecting equipment such as, though not limited to, gasoline storage tanks and flame proof cabinets, evaluating placement of fire equipment, evaluating firefighting equipment, measuring water pressures in standpipes, noting potential fire code violations, searching for fire hazards, reviewing emergency evacuation plans, and other functions. A life safety inspector may produce an inspection report for the commercial building operator at the end of the inspection which may provide the commercial building operator with the results of the inspection. An inspection report may be required by ordinance or regulation to be submitted to a local fire department or other government entity for record keeping. Should the commercial building operator experience a fire in a building they manage, the inspection report may be used as evidence in a court of law. Additionally, an insurance company may require the commercial building operator supply the insurance company with a record of the life safety inspections on the building before the insurance company will issue an insurance policy.

A building's life safety equipment may comprise several components such as, without limitation, a fire alarm system, a sprinkler system, fire extinguishers, and/or emergency lighting. In examples, the fire alarm system may comprise a fire alarm control panel which may monitor inputs, provide information about system integrity, control outputs, and provide an interface to control the rest of the fire alarm system. Each component of the fire alarm system may be directly or indirectly connected back to the fire alarm control panel through wired or wireless interfaces. A fire alarm control panel may provide power and signaling to other components of the fire alarm system. The fire alarm control panel may send signals to other components of a fire alarm system to, for example, activate notification devices such as sirens and warn building occupants that a fire alarm has been activated. Components of a fire alarm system may be digitally addressable through signaling line circuits. A fire alarm system may be considered a local network of interconnected components connected by a communications protocol communicated over wireless or physical connections. A digitally addressable component may receive an address, similar to an IP address for internet protocol devices, such that each device may be identified and communicated with.

Additionally, the control panel may provide a central location to interrogate components of the fire alarm system and act as a central point to troubleshoot problems with the fire alarm system or components thereof. A fire alarm control panel may provide status about the integrity of a fire alarm system by providing information about the readiness state of the fire alarm system. A system may be considered ready if the components of the fire alarm system are capable of responding to a fire condition. A system may be considered in a fault condition, or not ready, if a component is malfunctioning or a condition such as a power outage is causing the fire alarm system to operate in a battery mode. The fire alarm control panel may interface with components of the fire alarm system and provide information about the state of said components. In some instances, components of a fire alarm system may fail, such as with a short circuit, and a trouble code may be shown on an interface of the fire alarm control panel.

A fire alarm control panel may have testing capabilities to ensure the functioning of the fire alarm control panel interface. For example, there may be a function such as a lamp test to check the condition of LEDs or other light sources disposed on the fire alarm control panel. Additional testing functions may include, but are not limited to, voltage monitoring, software version checks, and others. Additionally, the fire alarm control panel may contain testing functions for enumerating function of each fire alarm system component. As previously mentioned, a fire alarm control panel may interface with components through a network or other connections wherein the individual components may report a status back to the fire alarm control panel. The fire alarm control panel may also be able to be put into a test mode to allow the individual components to be tested. For example, a fire alarm control panel may have a function for activating notification appliances of the fire alarm system.

In addition to providing power, networking, control, and other functions to a fire alarm system, a fire alarm control panel may, if a fire alarm initiation device such as a pull station is activated, initiate a fire alarm. A fire alarm may comprise activating notification appliances such as lights and sirens to alert occupants to a fire or other building hazard. A fire alarm control panel may have releasing capabilities. A releasing capability may be the ability to activate fire suppression systems such as water sprinklers or other fire-fighting agents into a building or selected portion of a building once a fire alarm has been activated. A fire alarm control panel may also interface with a first responders dispatch office such as a 9-1-1 emergency dispatch office. A first responder's dispatch office may be notified by the fire alarm control panel that a fire alarm has been activated. In some instances, the fire alarm system may provide information such as a building zone the fire alarm was activated in.

Further, a fire alarm system may comprise a plurality of fire alarm control panels. For instance, one fire alarm control panel may not provide enough inputs or outputs in certain buildings. Additionally, in situations where multiple building's fire alarm systems are controlled from a central location, multiple fire alarm control panels may be necessary. In some instances, fire alarm control panels may be networked together to provide redundancy to the fire alarm system or to interface with other components of a commercial building's building safety interfaces. Specific building safety interfaces are further discussed below.

The fire alarm system may further comprise a source of power such as a primary power supply, typically in the form of a hardwired 110 volt or 220 volt power from a circuit breaker box. The primary power supply may be coupled to the one or more fire alarm control panels. A fire alarm system may further comprise a backup power supply such as a bank of batteries or on-demand generators for powering the fire alarm system should the primary power supply fail. As previously discussed, each component of the fire alarm system may receive power, signaling, or both from the fire alarm control panel. In some examples where the fire alarm system component is wireless and does not receive power from the fire alarm control panel, a separate auxiliary power source may be provided to the component. For example, a wireless smoke detector may receive power from an internal battery pack contained in the wireless smoke detector or from a hardwired power source separate from other power supplied from the fire alarm control panel.

The fire alarm system may further comprise initiating devices such as manual pull stations, break glass stations, buttons, heat detectors, rate-of-rise heat detectors, flame detectors including optical flame detectors, UV flame detectors, IR flame detectors, smoke detectors, fire gas detectors such as carbon monoxide detectors, camera-based detectors, water flow detectors, air aspiring detectors, and other initiating devices well known in the art. The initiating devices may comprise a power source provided by the fire alarm control panel or an alternate power source such as an internal battery or a dedicated power line separate from the fire alarm control panel. As previously described, the initiating devices may interface with the fire alarm control panel to provide a signal to the fire alarm control panel to activate a fire alarm. Initiating devices may interface over a hardwired connection or a wireless connection.

The particular initiating devices required to be installed in a particular building or for a particular application may be governed, without limitation, by ordinances, building codes, regulations, laws, insurance policy, or industry requirements. For example, a commercial kitchen may be required to have heat detectors installed to detect an increase of room temperature to a set point above ambient. Smoke detectors may activate prematurely in a kitchen setting owing to a potential for haze and smoke to be generated during normal cooking activities. Initiating devices may be manually operated such as a glass break station or manual pull station, or automatically operated such as smoke detectors and heat detectors. Initiating devices may include a manual override function to cancel a signal sent to the fire alarm control panel, thus canceling a pending fire alarm or deactivating a currently active fire alarm.

Automatic initiating devices may have a control system comprising a set point wherein the automatic initiating device triggers a signal to the fire alarm control panel after a measurement from the initiating device falls below or exceeds a set point. Some set points may include, but are not limited to, concentration of particulate in air, temperature, and voltage. In some examples, the set point may come preset from a manufacturer and may not be adjustable by a user. Alternatively, some examples of automatic initiating devices may allow a custom set point to be entered by a user. In yet another example, a set point signal may be supplied by the fire alarm control panel to the automatic initiating device. An automatic initiating device may produce a signal through a detector which may be converted to a measurement. The measurement may then be compared to the set point in a control loop which may send an alarm signal to the fire alarm control panel if the measurement falls below or exceeds the set point. An example of a specific automatic initiating device may be a heat sensor having an internal set point of 194° F. (90° C.). The heat sensor may comprise a thermocouple, for example, that may constantly monitor the ambient temperature. A microchip may monitor a voltage signal produced by the thermocouple which may send a signal to the fire alarm control panel after the ambient room temperature, where the heat sensor is installed, reaches a temperature above 194° F.

The fire alarm system may further comprise notification appliances such as exit signs, flashing lights, strobe lights, emergency exit lighting, alarms, horns, directional sounders, chimes, low frequency sounders, voice evacuation systems, and other notification appliances well known in the art. Notification devices may produce an alert such as a visual flashing alert, an audible alert, an olfactory alert, or any combinations thereof. Notification devices may comprise a power source provided by the fire alarm control panel or an alternate power source such as an internal battery or a dedicated power line separate from the fire alarm control panel. Notification devices may interface with the fire alarm control panel to accept a signal to the fire alarm control panel to activate a fire alarm. Notification appliances may interface over a hardwired connection or a wireless connection. A notification appliance may receive a control signal from the fire alarm control panel to activate the notification device and produce an alert. The control signal may be sent to the notification device after an initiating device has sent a signal to the fire alarm control panel to activate the fire alarm.

As with initiation devices, the particular notification appliances required to be installed in a particular building or for a particular application may be governed, without limitation, by ordinances, building codes, regulations, laws, insurance policy, or industry requirements. Alerting method may also be governed by codes and regulations. In particular, an audible alert generated by a notification device must comply with the National Fire Protection Association (NFPA) standards in force at the time a building is constructed or renovated. For example, an NFPA standard may require an audible alert to be at least 15 Decibel (dB) above the ambient sound level of a room or 5 dB above the maximum sound level having a duration of at least 60 seconds, whichever is greater, measured at 1.5 m (5 ft) above the floor in the occupiable area, using the A-weighted scale (dBA).

The fire alarm system may further comprise building safety interfaces that may prepare a building for a fire. Some non-limiting examples or building safety interfaces may include duct smoke detectors designed to shut off fans and close dampers to prevent smoke migration through ducting, emergency door recall systems such as systems designed to automatically open or close doors to prevent the spread of a fire, emergency recall systems for elevator systems which may automatically initiate elevator emergency function such as automatic floor recall, process control override systems which may begin emergency shut down procedures in a chemical plant or other process equipment, and many other building safety interfaces well known in the art. Building safety interfaces may be directly controlled by the fire alarm system such as by the fire alarm control panel. In other instances, building safety interfaces may be controlled by other systems that may receive a control or status signal from the fire alarm system. A process control computer system may receive a signal from the fire alarm control panel that a fire alarm has been activated and may initiate emergency shutdown routines without further input from the fire alarm control panel.

The fire alarm system may further comprise a mass notification system or an emergency communication system. The mass notification system may extend the ability of the notification appliances by sending alerts to occupants of a building. The system may be able to send specific instructions for evacuation or alert occupants of a building to a specific threat to the building. For example, a system may be configured to alert occupants of a fire alarm or other building hazard through PC workstations, text message, e-mail messaging, RSS feeds, text-to-speech messaging, a mobile application, push notifications, or any combinations thereof. The mass notification system may rely on a positioning service, such as GPS, mobile network triangulation, Wi-Fi positioning, and others positioning services to send alerts to occupants of a specific building area to alert a building hazard. A mass notification system may also alert first responders to a building hazard and may be able to provide first responders with the location of a hazard within the building.

The fire alarm system may further comprise a fire suppression system such as sprinkler systems which may use water, water-foam, or water-mist to suppress a fire. Sprinkler systems may comprise several components including, but not limited to standpipes and other water delivery means, pressure gauges, pressure switches, water flow detectors, supervisory switches, and sprinkler heads. A second fire suppression system may be a gaseous fire suppression system which may utilize an inert gas which may displace oxygen from fuel, may burn to produce species that quench and prevent further combustion, or may reduce heat available such that combustion ceases. A third fire suppression system may comprise a condensed aerosol fire suppression system which may employ an aerosol fire extinguishing agent to suppress a fire. As previously discussed, the fire alarm control panel may have releasing capabilities wherein the fire alarm control panel may be configured to interface with a sprinkler system to activate the sprinkler system. Alternatively, a sprinkler system may be able to activate at individual sprinkler heads, for example, by breaking glass bulbs holding back pipe pressure when a certain set point temperature is reached.

A building may be required by code or regulation to have ancillary fire equipment. For example, a building may be required to have fire hoses or fire extinguishers available for use by occupants or first responders. In certain buildings, such as laboratories, a fire blanket, respirator, and fume hood may be required. In a commercial kitchen, vent hoods capable of containing a fire may be required, and in some instances, vent hoods with sprinklers may be required.

One of ordinary skill in the art will appreciate that performing a fire inspection on a fire alarm system may be a complex task for a multitude of reasons. A fire alarm system may comprise a large number of individual pieces of equipment each of which may be manufactured by a large number of manufactures each with different equipment designs and testing standards. Building safety interfaces may comprise complex management systems that interface with the fire alarm system, allowing proper function. Regulations and codes may be complex and difficult for an inspector to recall at all times. Testing procedures may vary for the same class of fire alarm system components between different manufacturers.

A life safety inspection may comprise a plurality of tests to determine functioning and compliance of a fire alarm system component. The exact tests a particular fire alarm system component must undergo during an inspection may be determined by regulations, ordinances, manufacturer procedures, or any other number of sources. For example, a test of a hard wired notification appliance such as a strobe light may comprise a visual or physical inspection of the strobe light to ensure the strobe light has not been damaged, visual inspection to ensure the strobe light is not obstructed from view, visual inspection of the mounting mechanism, visual inspection of power and/or signal wire to the strobe light to ensure proper wire was used during insulation, visual inspection of any backup battery or alternative power source, visual inspection for corrosion, visual inspection of stake-on or other wire fasteners to ensure proper clamping force is exerted, visual inspection of wire strain relievers, or any other visual test well known in the art. Another test may be an electrical test of the strobe light using electrical measurement equipment such as a multimeter. Electrical tests may comprise, for example, checking for grounding errors and faults, voltage fluctuations at idle and during operation, voltage drop from power wires running from the fire alarm control panel, or any other electrical tests. Another test may be a functional test of the strobe light to ensure the strobe light flashes when a fire alarm is signaled by the fire alarm control panel. The functional test may comprise entering a test mode or fire drill mode on the fire alarm control panel and ensuring the strobe light is activated when the test mode or fire drill mode is activated.

In addition to physical, visual, electrical, and functional tests of the strobe light, additional tests may be required to determine if the strobe light is in compliance with applicable fire codes. Regulations or codes may require brightness of the strobe light to vary based on the size of a room. A strobe light that passes all physical, visual, electrical, and functional tests may still not be code compliant if the strobe light is not large enough or bright enough for a given room. A fire inspector may take measurements such as room size, ceiling height, average distance to strobe, and/or brightness measurements from several parts of the room and compare the results to applicable codes.

Another test that may be performed as part of a life safety equipment inspection may be tests required by the manufacturer. A manufacturer may require the strobe light to be interrogated using the fire alarm control panel for example. In examples, the interrogation may comprise running diagnostic routines on the strobe light. Furthermore, the manufacturer may require confirmation of a software version and an update if it is out of date.

Although only a few tests have been described herein for a single piece of equipment, one of ordinary skill will appreciate that there may be numerous other tests which may be performed during an inspection of any fire alarm system component and/or any component of other life safety equipment. One of ordinary skill in the art would further understand that the complexity of a life safety equipment inspection may rapidly increase as the number of individual components of a fire alarm system and/or other life safety equipment is increased. Furthermore, one of ordinary skill in the art will readily appreciate that conducting a life safety inspection on relatively complex system using a paper inspection may be time consuming and the inspection may be inaccurate due to the multitude of questions that need to be answered for even a single component of a fire alarm system.

A system and method are described herein that may produce faster and more accurate life safety equipment inspection. A life safety equipment inspection system may comprise a media device, an interface disposed on the media device, and a server. The media device may be any media device with networking capability such as, without limitation, desktop computers, laptop computers, tablet computers, and smartphones. The media device may be connected to a network such as a wireless network, wired network, or media data network, which may provide access to the internet. The media device may connect to the server over the internet thereby providing a means to transmit data between the media device and the server.

The interface may provide a user with a means for interacting with an application running on the media device. The application may provide functionality such as assistance in preparation and execution of a life safety equipment inspection. A life safety inspector may start a new life safety equipment inspection using the interface.

The server may comprise a database. The database may comprise data for performing a life safety equipment inspection as well as customer information and completed life safety equipment inspections. Data for performing a life safety equipment inspection may include, for example, fire code regulations, building code regulations, local fire ordinances, and other regulatory frameworks for fire safety. An example of a life safety code may be the NFPA 1 also known as the National Fire Protection Association fire codes. NFPA 1 may provide a body of best practices, codes, and standards for fire safety. In general, a municipality may require through ordinance or other local laws that a building must be in compliance with the NFPA 1 to receive occupancy permits and avoid fines.

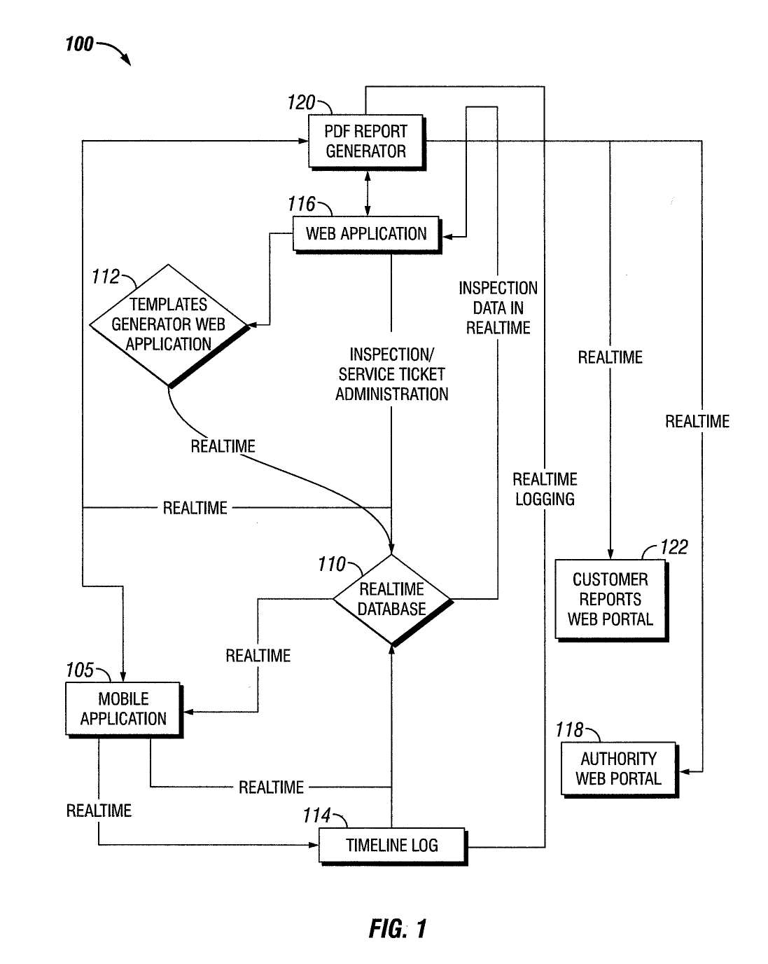

With reference to FIG. 1, a life safety equipment inspection method 100 is illustrated using a logic flow diagram wherein each box represents a particular component of method 100 and each arrow represents the transmission of data throughout the execution of method 100. FIG. 1 shows that the transmission of data of method 100 all happens in real time. Beginning with a mobile application 105, a life safety inspector may use a media device, comprising an interface capable of interacting with the mobile application 105, to select a building to be inspected. The interface may present a list, such as a drop-down list, populated from a real time database 110 located on a server. The method may proceed in determining whether or not the desired building for inspection is listed in the mobile application and by extension, determining whether or not the building's information is present in real time database 110. If the building is listed, the life safety inspector may select the building and proceed to inspect the life safety equipment of the building. If the building is not listed, the user may click on a button or similar interface element to indicate that a new building is to be entered and proceed in adding new data associated with the building to real time database 110.

Data associated with the building may be transmitted to mobile application 105 from real time database 110. As will be illustrated further in other figures, the data may comprise a list of life safety equipment installed at the building as well as fire codes the building should be in compliance with. Additional data that may be transmitted may include testing procedures for equipment and user manuals for equipment. Once mobile application 105 of a media device has received the data from real time database 110, the software may populate form fields on the interface of mobile application 105 with the data from real time database 110. For example, a plurality of fields may be populated with a list of life safety equipment.

When the desired building is not listed in mobile application 105 and by extension real time database 110, a user may be prompted to enter information about the building including, but not limited to, name of the building, address of the building, contact information for the building, and the components of the life safety equipment installed in the building. A partial list of life safety equipment components was discussed previously. The interface may present a prompt for the life safety inspector to select a category of life safety equipment components to begin to build a list of the life safety equipment components installed in the building. In examples, a prompt may call for the life safety inspector to enter information about a fire alarm control panel installed in the building. A list of fire alarm control panel manufacturers may be shown on the interface and the life safety inspector may select a manufacturer of the fire alarm control panel from the list presented on the interface of mobile application 105. After the manufacturer is selected, a second list may be shown on the interface of mobile application 105 to select a model of fire alarm control panel offered by the manufacturer. Additional prompts may be shown to the life safety inspector to record additional information about the fire alarm control panel such as, for example, serial number, location, number of circuits or addressable points in use, circuit styles installed, software version, firmware version, revision date of software and firmware, transmission types available, connected devices, power supply type and voltage, and disconnecting means location. Information may be entered into an input field such as a text box, input as radio buttons, input from a drop-down list, or any other method well known in the art. The information may then be transmitted to real time database 110 and may be used for future inspections. This example is non-exhaustive, non-limiting, and should be clear to those skilled in the art that recordation of the fire alarm control panel may be applied to any life safety equipment component that may be inspected by a life safety inspector.

After information about the first component of life safety equipment has been entered, a life safety inspector may select a button on the interface to add another piece of equipment. The interface may again present a prompt for the life safety inspector to select a category of life safety equipment and prompts may be shown to enter information about the equipment selected. The life safety inspector may walk through the entire building and build the list of life safety equipment components installed in the building. Prompts shown on the interface may be generated based on, for example, the type of equipment selected, the manufacturer, by code or regulation for required information about the equipment, or any combination thereof. The fire inspector may choose to end adding equipment at any time by selecting an appropriate button on the interface. The information about a particular building and the building's life safety equipment may be stored in real time database 110 as a template for future inspections of the present building as well as other buildings with similar life safety equipment. Further, the templates may be accessed, modified, and/or generated using a web-based application, illustrated in FIG. 1 as a template generator web application 112.

Information entered into input fields may be transmitted to real time database 110 and recorded as part of a record of life safety equipment installed at the building. Each piece of information input may be associated with the corresponding piece of equipment in real time database 110 such that a user can retrieve the information at a later time.

In examples, a life safety inspector may begin inspecting life safety equipment components either previously entered using mobile application 105 or retrieved from real time database 110. As previously discussed, the life safety equipment inspection may comprise the life safety inspector answering a series of questions about a life safety equipment component being inspected. The questions may come from various sources such as regulations, codes, ordinances, and manufacturer requirements which may also be stored in real time database 110. In one example, real time database 110 may comprise a list of all questions that need to be answered for a particular life safety equipment component for a particular set of regulations, codes, ordinances, and/or manufacturer requirements. At the beginning of the inspection, the interface interacting with mobile application 105 may present the life safety inspector with a list of life safety equipment components associated with the building. The life safety inspector may select a component of the life safety equipment using the interface to begin the inspection of the life safety equipment. Software running on the media device comprising mobile application 105 may query real time database 110 to provide the required list of questions for the selected life safety equipment.

A prompt containing a first question from the required list of questions may be presented on the interface interacting with mobile application 105. The life safety inspector may enter an answer to the first question using an input field such as a text box, input as radio buttons, input from a drop-down list, or any other method. After entering an answer to the first question, a second prompt containing a second question from the required list of questions may be presented on the interface. The life safety inspector may enter an answer to the second question using an input field. Prompts containing questions from the required list of questions may continue to be shown and answers entered until each question from the required list of questions is answered.

Inspecting some life safety equipment components may require a loudness or a decibel test to be performed. For example, an audible notification device may be required by code or statute to be of a certain loudness above background noise. An inspector may select an audible notification device such as a siren using the interface of mobile application 105. A prompt on mobile application 105 may be shown requiring the life safety inspector to perform a decibel test. A media device comprising a microphone may be used to perform the decibel test. Mobile application 105 running on the media device may interface with the microphone and take audio samples to determine the loudness of the siren measured in decibels. A loudness for an ambient sound level may also be measured in decibels.

Additionally, a light meter or brightness test may be required for inspecting a life safety equipment fire alarm system component. A media device comprising a light sensor and/or camera may be used to perform the brightness test. Mobile application 105 running on the media device may interface with the light sensor and/or camera capable of recording light measurements to determine the brightness of a notification appliance such as a strobe.

A life safety inspector may also take a picture or video using the media device. In some examples, the questions asked may not cover everything required during a life safety equipment inspection. For example, unsafe conditions may exist in a building that may be better reported with a video or picture. Mobile application 105 running on the media may interface with the camera capable of recording pictures and videos.

In examples, a life safety inspector may want to test or analyze signals sent from a life safety equipment component. Analysis of the signals may be performed by placing the life safety equipment into a test mode wherein software on the media device may interface with a central station. The central station may be used for one-way communication with the life safety equipment. The software on the media device may interact with an API (Application Programming Interface) provided by the central station so the software may receive the signals sent by the life safety equipment. The signals may be captured and analyzed by the software and displayed to the life safety inspector.

A life safety inspector may also select comments to add to an inspection of a life safety equipment component. Comments may be manually typed or selected from a pre-generated list. A source for comments in a pre-generated list may be fire code regulations. For example, if a life safety inspector measures that a smoke detector is incorrectly placed, the life safety inspector may choose to reference a fire code regarding placement of smoke detectors as a comment.

The life safety equipment may be laid out on a map on the media device. For example, a building map may display the location of life safety equipment components on the map. An inspector may select the life safety equipment component on the map and begin an inspection on the component.

The software may further comprise a capability to scan a barcode to identify a component of life safety equipment. A life safety inspector may scan a barcode that identifies the life safety equipment component and begin an inspection on the component. Barcode scanning may also be implemented using an external barcode scanning device that may be connected to the media device via Bluetooth or wired connection.

In examples, a timeline log 114 of answers to each question may be transmitted to real time database 110 and each answer may be associated with a corresponding component of the life safety equipment the question pertained to. Additionally, pictures, videos, audio samples, and results of loudness and brightness tests may be transmitted. Metadata such as inspection progress, timestamp, inspector name, inspector identification number, GPS coordinates where the question was answered, and other metadata may also be transmitted and stored in timeline log 114 which is further transmitted to real time database 110.

In examples, method 100 may comprise a web application 116 that may access data from real time database 110. Web application 116 may be used by authority members such as, supervisors, building managers, or fire marshals who may visualize, in real time, the life safety equipment inspection as a life safety inspector completes inspections of the life safety equipment components. The authority member may be provided with, for example, a timestamped and/or location stamped real time feed of each life safety equipment component being inspected. With this method the authority member may remotely monitor life safety inspectors without having to be present at a building being inspected. Further, the authority member may access template generator web application 112 using web application 116. With this ability, authority members are capable of creating templates for life safety inspections, comprising building information, life safety equipment information, and questions that need to be answered by life safety inspectors. The authority member may access the real time feed through authority web portal 118, which may comprise a plurality of methods including, but not limited, push notifications, a monitoring application on a smart phone, an application running on a tablet or laptop computer, an application running on a desktop computer, or a web portal.

As previously discussed, a life safety equipment inspection may comprise a plurality of tests to determine functioning and compliance of life safety equipment components. In examples, a plurality of life safety inspectors may perform the plurality of tests. In these instances, an authority member may schedule each inspector from the plurality of inspectors to perform a particular set of tests. Scheduling may be done through authority web portal 118 using any internet enabled media device previously discussed.

In examples, an authority member may communicate with a life safety inspector performing the life safety equipment inspection using a chat feature within mobile application 105 and web application 116. The authority member may enter into a chat dialogue box a message using authority web portal 118, which may be transmitted to the life safety inspector's media device comprising mobile application 105 and displayed on the interface. This method may allow authority members to make corrections and/or suggestions to the life safety inspector during life safety equipment inspections.

Once a life safety equipment inspection has been completed, a life safety inspection report may be generated using PDF generator report 120. The report may comprise answers to the questions asked for each life safety equipment component inspected. The report may also comprise time stamped and/or location stamped answers to the inspection questions in order to verify that the life safety equipment was actually inspected. Method 100 allows customers such as, without limitation, building managers, site representatives, insurance agents, or combinations thereof to verify that the life safety equipment inspection actually took place and that each component of life safety equipment that was supposed to be inspected was actually inspected. In examples, a life safety inspection report created using PDF report generator 120, may be provided to a customer and may be accessed using customer report web portal 122. Customer report web portal 122 may comprise push notifications, a monitoring application on a smart phone, an application running on a tablet or laptop computer, an application running on a desktop computer, or a web portal. The life safety inspection reports may be more easily accessible to customers through the use of QR code scanning. QR codes may be prepared and attached to life safety equipment components that have been inspected and may be linked to reports and summaries of a particular component. By this method, a customer may easily access inspection reports of a life safety equipment component using a media device discussed previously.

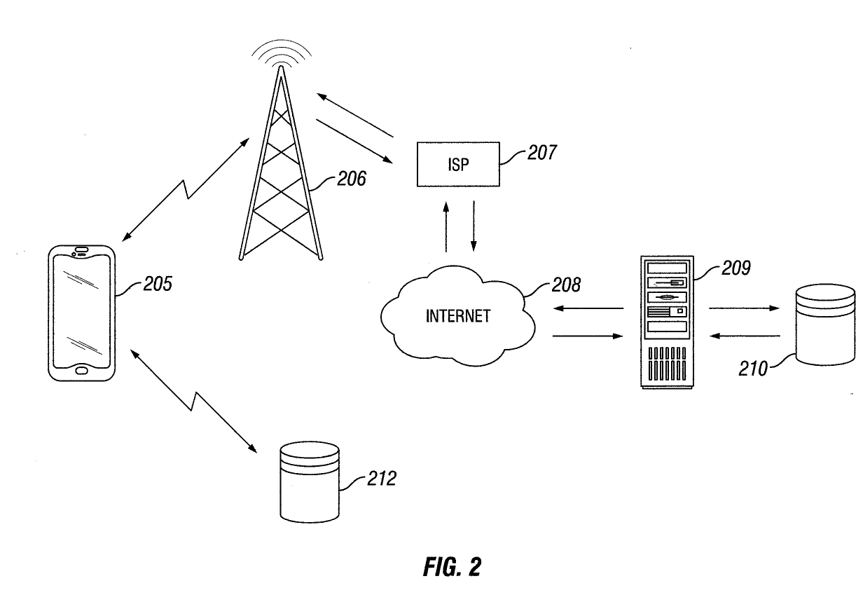

With reference to FIG. 2, a diagram for a media device communicating with a database is illustrated. Media device 205 may be any media device previously discussed. FIG. 2 illustrates media device 205 as a smartphone with a wireless data connection to mobile tower 206. An example wireless data connection may be Wi-Fi, 2G, 3G, 4G, or any other wireless data connection well known in the art. Mobile tower 206 may communicate with an internet service provider (ISP) 207 which may provide access to internet 208. Server 209 may communicate with media device 205 through the connections provided through internet 208. Online database 210 may communicate with server 209. Server 209 may provide media device 205 access to database 210 through internet 208 such that media device 205 may make database calls to retrieve data stored in online database 210 as well as push data to be stored in online database 210. In examples, media device 205 may be offline or become disconnected from internet 208. When this occurs, a life safety equipment inspection may still progress through the use of offline database 212. Offline database 212 allows for a fire inspector to continue inspecting life safety equipment components by continuing to record data in real time. When media device 205 reestablishes a connection with internet 208, data from offline database 212 may be automatically transferred to online database 210.

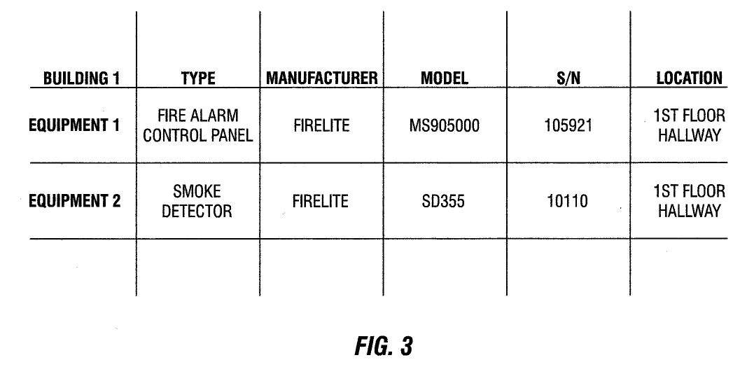

With reference to FIG. 3, an example database is illustrated. The database may be online or offline and comprise an identifier such as “Building 1” as illustrated. The identifier may be any identifier that may uniquely identify the building. Another identifier may be, for example, Big Corporation—Headquarters. Although not illustrated in FIG. 3, the database may comprise further identifiers about the building such as address, main phone number, contact information for building management and owners, and fire code regulations the building must conform to. The regulations the building must conform to may be determined by local ordinance or any other regulation as previously discussed. As illustrated in FIG. 3, the database may comprise a list of life safety equipment installed at the building as well as information about the equipment, including, but not limited to, type of equipment, manufacturer, model, serial number, and location.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the methods are described in terms of “comprising,” “containing,” or “including” various components or steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system for inspecting life safety equipment comprising:
a media device comprising an interface; and
a server comprising a database.

2. The system of claim 1, wherein the media device is capable of connecting to a wireless network, a wired network, mobile data network, or any combination thereof.

3. The system of claim 1, wherein the media device connects to the server over the internet thereby providing a means to transmit data between media device and server.

4. The system of claim 1, wherein the interface provides a user a means for interacting with an application running on the media device.

5. The system of claim 1, wherein the database comprises data for performing a life safety inspection, wherein the data comprises:
customer information;
fire code regulations;
building code regulations; and
local fire ordinances.

6. The system of claim 5, wherein the data further comprises:
a list of fire alarm system equipment;
testing procedures for each piece of the life safety equipment; and
user manuals for the life safety equipment.

7. The system of claim 1, wherein the media device further comprises
an offline database, wherein the offline database is used to store data when the media device is offline; and
a timeline log, wherein the timeline log records the time in which a part of the life safety equipment inspection takes place.

8. The system of claim 1, further comprising a web application that is used by an authority member to view the progress of a life safety equipment inspection.

9. A method for fire alarm system inspection comprising:
scheduling at least one life safety inspector to perform a life safety equipment inspection;
prompting the at least one life safety inspector to perform a plurality of tests with a system for inspecting life safety equipment;
collecting data from the at least one life safety inspector with the system for inspecting life safety equipment; and
generating an inspection report.

10. A method of claim 9, wherein scheduling the at least one life safety inspector is performed by an authority member with a web application.

11. A method of claim 9, wherein the plurality of tests is performed on life safety equipment.

12. A method of claim 9, wherein the system for inspecting life safety equipment comprises:
a media device comprising an interface; and
a server comprising a database.

13. The method of claim 12, wherein the media device is capable of connecting to a wireless network, a wired network, mobile data network, or any combination thereof.

14. The method of claim 12, wherein the media device connects to the server over the internet thereby providing a means to transmit data between media device and server.

15. The method of claim 12, wherein the interface provides a user a means for interacting with an application running on the media device.

16. The method of claim 12, wherein the database comprises data for performing a life safety equipment inspection, wherein the data comprises:
customer information;
fire code regulations;
building code regulations; and
local fire ordinances.

17. The method of claim 16, wherein the data further comprises:
a list of life safety equipment;
testing procedures for each piece of the life safety equipment; and
user manuals for the life safety equipment.

18. The method of claim 12, wherein the media device further comprises:
an offline database, wherein the offline database is used to store data when the media device is offline.
a timeline log, wherein the timeline log records the time in which a part of the life safety equipment inspection takes place.

19. The method of claim 9, further comprising a web application that is used by an authority member to view the progress of a life safety equipment inspection.

20. The method of claim 9, wherein generating the inspection report is based on data collected by a life safety inspector.
